(19) United States
(12) Patent Application Publication
(10) Pub. No.: US 2008/0289941 A1
(43) Pub. Date: Nov. 27, 2008

(54) Rotary input apparatus

(75) Inventors: Eung Cheon Kang, Hwasung (KR); Min Kyu Shin, Hwasung (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/076,435

(22) Filed: Mar. 18, 2008

(30) Foreign Application Priority Data
May 21, 2007 (KR) 10-2007-0027563

(51) Int. Cl. H01H 19/00

(52) U.S. Cl. 200/336

(57) ABSTRACT

There is provided a rotary input apparatus including: a rotating wheel having a detected part; a board provided with a detecting part detecting the detected part rotating along with the rotating wheel; a base having the board disposed on a top thereof and provided with a plurality of guide holes therein; and a holder having the rotating wheel rotatably assembled therewith, and provided with a plurality of guide protrusions inserted through the guide holes to be exposed to a bottom of the base and having lower ends thereof stuck into the guide holes, respectively, the holder disposed between the rotating wheel and the board. The apparatus, when assembled in an assembly line, experiences minimum interference with other members, thereby enhancing work efficiency and ensuring more freedom in design.

### CROSS-REFERENCE TO RELATED APPLICATIONS

This application claims the priority of Korean Patent Application No. 2007-0027563 filed on Mar. 21, 2007, in the Korean Intellectual Property Office, the disclosure of which is incorporated herein by reference.

### BACKGROUND OF THE INVENTION

1. Field of the Invention

The present invention relates to a rotary input apparatus, and more particularly, to a rotary input apparatus in which a base and a holder are assembled together within a radius of a rotating wheel to experience minimum interference with other members in an assembly line, thereby enhancing work efficiency and ensuring more freedom in design.

2. Description of the Related Art

In general, a mobile terminal has 12 key pads marked with numbers 0 to 9, and signs * and #. The key pads feature English letters and consonants and vowels of Korean letters other than the numbers and thus data such as numbers and letters can be inputted using the key pads.

Furthermore, recently, the mobile terminal is provided with a navigation key above the key pads to perform various functions such as search for phone numbers, text message writing and management, and internet logging.

This navigation key is variously configured, for example, in a button type and a rotary type. Of late, the navigation key increasingly employs a rotary input apparatus capable of performing various functions including menu search. Also, the rotary input apparatus is utilized as a rotary switch, a rotary encoder, a rotary volume and the like in a variety of electronic products such as a television, a camcorder and a personal digital assistant (PDA).

Korean Patent Publication No. 10-2006-0105542 discloses a rotary input apparatus including an operation dial, a metal base and an operation plate. The operation dial includes a magnet, and the metal base has a printed circuit board provided with Hall elements mounted thereon and elastic engagement receivers formed at edges thereof. The operation plate has the operation dial rotatably assembled via a slide sheet and elastic poles formed at an outer periphery thereof to be stuck into the elastic engagement receivers.

However, in this conventional apparatus, when the operation plate and the metal base are assembled together, the elastic poles protruded in a predetermined length from the outer periphery of the operation plate is elastically inserted into the elastic engagement receivers protruded in a predetermined height from a top of the metal base so that a portion where the elastic poles and the elastic engagement receivers are assembled together is protruded outward.

In this case, when the assembled apparatus is assembled to an electronic apparatus, for example, a mobile terminal, such a protruded portion interferes with other adjacent members, thereby disturbing an assembling process. Also, the protruded portion complicates design of an outer case of the electronic apparatus.

### SUMMARY OF THE INVENTION

An aspect of the present invention provides a rotary input apparatus which experiences minimum interference with other members when assembled in an assembly line, thereby enhancing work efficiency and ensuring more freedom in design.

According to an aspect of the present invention, there is provided a rotary input apparatus including: a rotating wheel having a detected part; a board provided with a detecting part detecting the detected part rotating along with the rotating wheel; a base having the board disposed on a top thereof and provided with a plurality of guide holes therein; and a holder having the rotating wheel rotatably assembled therewith, and provided with a plurality of guide protrusions inserted into the guide holes and exposed to a bottom of the base to have lower ends thereof stuck into the guide holes, respectively, the holder disposed between the rotating wheel and the board.

The holder may have a center hole of a predetermined size perforated in a center thereof to be assembled with the rotating wheel by a fixing ring.

The fixing ring may have a plurality of rotating holes perforated therein to have a plurality of fixing protrusions protruded from a bottom of the rotating wheel inserted thereinto.

The guide protrusions may be disposed within a rotating radius of the rotating wheel.

Each of the guide protrusions may include: a guiding part of a predetermined length disposed in a corresponding one of the guide holes of the base to be vertically movable; and a sticking part formed on a lower end of the guiding part, the sticking part inserted through the guide hole to be stuck into the lower end of the guiding part.

The sticking part may be formed of an elastic tongue split apart to generate an elastic force in a center thereof and protruded outward.

The sticking part may be exposed downward through the guide holes and fused by a heat source to form a fusion protrusion having an outer circumference greater than an inner circumference of the guide hole.

The rotating wheel may further include a center key inserted into a center hole perforated in the center thereof.

The center key may have a flap formed on a lower end thereof to be stuck into a step formed on an inner surface of a center hole.

The rotating wheel may be provided on a bottom thereof with a positioning recess where the detected part is positioned.

The rotating wheel may be provided in a bottom thereof with a slip ring groove where a slip ring is disposed to abut against a top of the holder.

The detecting part may be formed of one of a hall sensor, a magneto resistor and a great magneto resistor.

The board may include a plurality of dome buttons generating a signal when in contact with a plurality of pressing protrusions protruded from a bottom of the holder, respectively.

The board may include a plurality of center dome buttons generating a signal when in contact with a center key inserted into a center hole perforated in a center of the rotating wheel.

The center dome buttons or dome buttons may be formed of one of a pressure sensor and a contact sensor.

The base may include a vertical rib of a predetermined height having an upper end stuck into a center key inserted in a center hole perforated in the rotating wheel to prevent the center key from rotating.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a longitudinal cross-sectional view illustrating a rotary input apparatus according to an exemplary embodiment of the invention;

FIG. 2 is an exploded view illustrating a rotary input apparatus according to an exemplary embodiment of the invention;

FIG. 3 illustrates a rotating wheel provided in a rotary input apparatus according to an exemplary embodiment of the invention, in which A is a plan view and B is a rear view;

FIG. 4 is a plan view illustrating a board provided in a rotary input apparatus according to an exemplary embodiment of the invention;

FIG. 5 is a plan view illustrating a base provided in a rotary input apparatus according to an exemplary embodiment of the invention;

FIG. 6 is a holder provided in a rotary input apparatus according to an exemplary embodiment of the invention, in which A is a plan view and B is a plan view;

FIG. 7 is a plan view illustrating a fixing ring provided in a rotary input apparatus according to an exemplary embodiment of the invention;

FIG. 8 illustrates a holder provided in a rotary input apparatus according to another exemplary embodiment of the invention, in which A is a plan view, B is a side sectional view and C is a rear view; and

FIG. 9 is a longitudinal cross-sectional view illustrating a rotary input apparatus including the holder of FIG. 8 according to another exemplary embodiment of the invention.

### DETAILED DESCRIPTION OF THE PREFERRED EMBODIMENT

Exemplary embodiments of the present invention will now be described in detail with reference to the accompanying drawings.

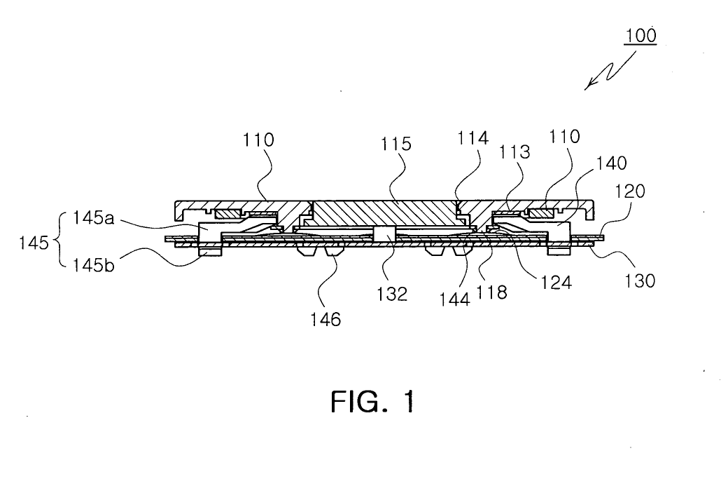

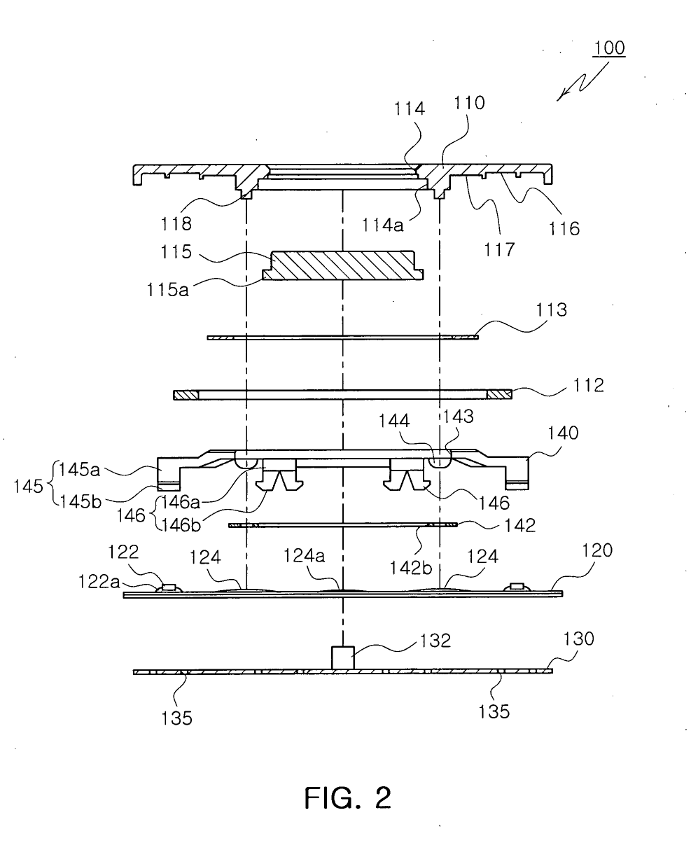

FIG. 1 is a longitudinal cross-sectional view illustrating a rotary input apparatus according to an exemplary embodiment of the invention and FIG. 2 is an exploded view illustrating a rotary input apparatus according to an exemplary embodiment of the invention.

As shown in FIGS. 1 and 2, the rotary input apparatus 100 of the present embodiment includes a rotating wheel 110, a board 120, a base 130 and a holder 140. Rotating wheel

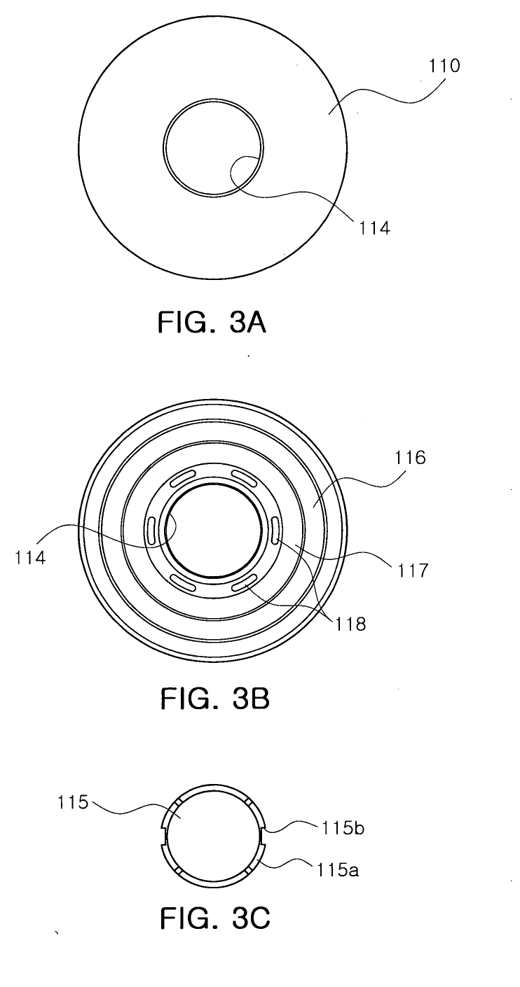

As shown in FIG. 1 to FIGS. 3A, 3B and 3C, the rotating wheel 110 is a disc-shaped rotating member having a detected part disposed on a portion of a bottom thereof corresponding to the holder 140.

The rotating wheel 110 is provided in a center thereof with a center hole 114 perforated in a predetermined size to have a center key 115 inserted thereinto. The center hole 114 has a step 114a provided on an inner surface thereof. Also, a flap 115a is formed at an outer periphery of a lower end of the center key 115 to be stuck into the step 114a, thereby prevented from being detached upward.

The flap 115a is provided with a rotation-prevention groove preventing rotation of the center key 115 where an upper end of a vertical rib 132 formed on the base 130 is disposed.

Here, the detected part 112 of the present embodiment includes but not limited to at least one magnet. The detected part 112 may be formed of a reflecting plate reflecting light or a contact detection sensor sensing change in capacitance.

The detected part 112 is a ring-shaped magnet fixedly disposed in a positioning recess 116 recessed in the bottom of the rotating wheel 110 to be rotated along with the rotating wheel 110. This magnet is detected by a detecting part 122 such as a hall sensor described later and input is performed according to a rotational angle thereof.

Accordingly, the magnet has an N pole and an S pole alternating in a circumferential direction, and the detecting part 122 is disposed just below the magnet and detects a rotational angle, direction and speed of the rotating wheel 110 according to a positional change in the N pole or S pole of the magnet rotating along with the rotating wheel 110 by operation of a user.

A slip ring groove 117 is formed in a ring shape inside the positioning recess 116 to have a slip ring 113 abutting against a top and bottom of the holder 140, respectively fixedly disposed therein.

### Board

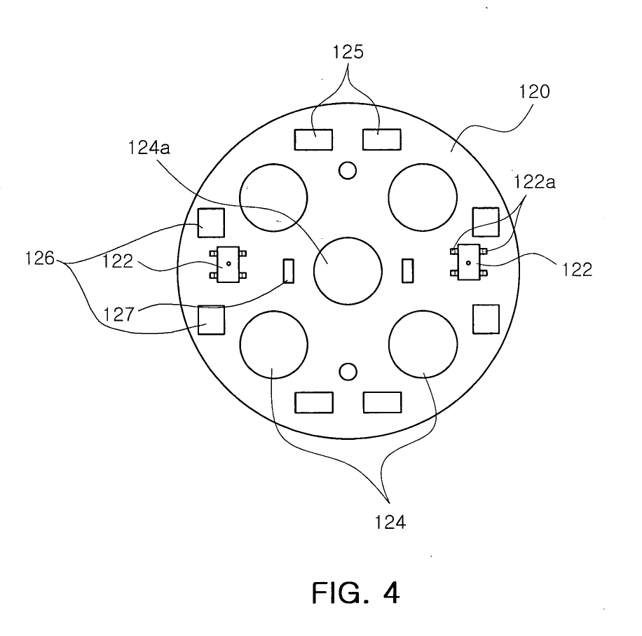

As shown in FIGS. 1, 2 and 4, the board 120 has at least one detecting part 122 electrically mounted on a portion of a top thereof corresponding to the magnet, i.e., the detected part 112 to detect the magnet rotating along with the rotating wheel.

Here, the detecting part 122 may be formed of a hall sensor which is a silicon semiconductor utilizing an effect of electromotive force generated when an electron within a magnetic field is bent in a motional direction under Lorentz force. This hall sensor generates a field power in proportion to a rotational amount of the magnet provided in the rotating wheel 110, and transfers the field power to an external controller (not shown) through a pattern circuit of the board 120.

The detecting part 122 is formed of such a hall sensor but not limited thereto. The detecting part 122 may be formed of any structure capable of detecting a rotational amount of the magnet rotating along with the rotating wheel 110. For example, the detecting part may be structured as an magneto resistor (MR) or a great magneto resistor (GMR). The MR sensor or the GMR sensor has a resistance varied according to change in magnetic field, and utilizes change in resistance occurring when a path of carriers in a solid is bent and lengthened by electromagnetic force.

Here, the MR sensor or the GMR sensor is small in size, and exhibits a high signal level and superior sensitivity, thereby operable in a low magnetic field, and also assures high temperature stability.

When the detecting part 122 is formed of a hall sensor, a lead 122a extended outward from the hall sensor is electrically connected to a pattern circuit (not shown) formed on a top of the board 120.

Also, when the detected part 112 is formed of a reflecting plate, the detecting part is formed of an optical sensor including a light emitting device emitting light toward the reflecting plate and a light receiving device receiving light reflected on the reflecting plate, and thus can detect a rotational amount of the rotating plate rotating along with the detected part on an optical basis.

Moreover, when the detected part 112 is formed of a metal electrode formed on the bottom of the rotating wheel 110, the detecting part 122 is formed of a contact detecting sensor brought in contact with the metal electrode to sense change in capacitance according to a rotational amount of the rotating wheel, thereby capable of detecting a rotational amount of the rotating plate rotating along with the detected part on a capacitive basis.

A plurality of dome buttons 124 are formed on a top of the board 120. The dome buttons 124 are pressed by a plurality of pressing protrusions 144 protruded from a bottom of the holder 140 to generate a signal. Also, a center dome button 124a is formed on a portion of a bottom of the board corresponding to the center key 115. The center dome button 124a generates a signal when in contact with the center key 115.

Here, the dome buttons 124 may be arranged in a radial direction with respect to the center dome button 124a. The center dome button 124a and the dome buttons 124 may be substituted for a pressure sensor or a contact sensor which generate a signal when in contact with the center key 115 and the pressing protrusions 144, respectively.

A plurality of through holes 125 and 126 are formed in the board 120 to have a plurality of guide protrusions 145 and 146 formed on the holder 140 inserted therethrough. Also, other plurality of through holes 127 are formed in the board to have a vertical rib 132 formed on the base 130 described later inserted therethrough.

### Base

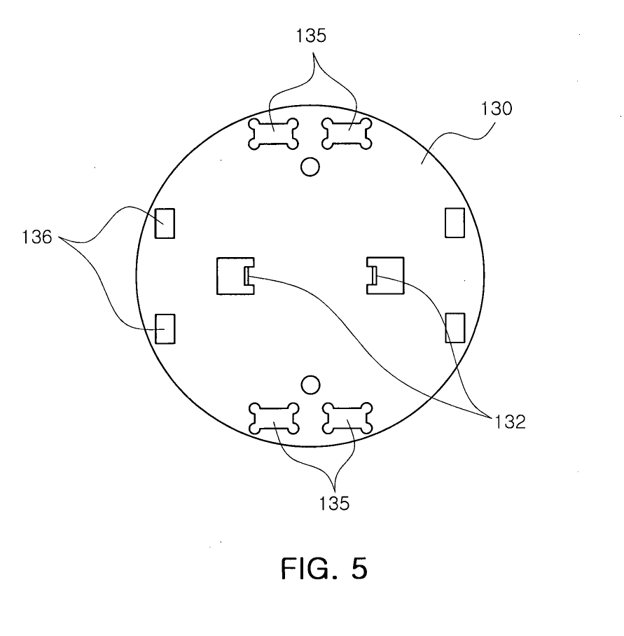

As shown in FIGS. 1, 2 and 5, the base 130 is a disc-shaped plate member having the board disposed on a top thereof.

A plurality of guide holes 135 and 136 are formed in the base 130 to align with the plurality of through holes 125 and 126 perforated in the board 120, and the plurality of guide protrusions 145 and 146 formed on the holder are inserted in the plurality of guide holes 135 and 136, respectively.

The base 130 is provided in a center thereof with a vertical rib 132 of a predetermined height exposed upward through the through hole 127 of the board 120 and having an upper end thereof stuck into the center key 115 inserted in the center hole 114 of the rotating wheel 110. This prevents the center key from rotating.

To form this vertical rib 132, in perforating the guide holes 135 and 136, the base is partially cut into an opening while still connected at one side to the remaining portion of the base. Then the portion of the opening connected to the base is bent upward at a right angle.

An upper end of the vertical rib 132 formed on the base 130 is stuck into a groove 115b formed in the center key 115 inserted into the center hole 114 of the rotating wheel 110.

As a result, in a case where the vertical rib 132 is not provided on the base 130, the center key 115 inserted into the center hole 114 rotates along with the rotating wheel 110 when the rotating wheel 110 is rotated by operation of a user.

On the other hand, in a case where the vertical rib 132 formed on the base 130 is stuck into the groove 115b of the center key 115, as opposed to what is described above, the center key 115 is prevented from rotating and thus letters or logos printed on an outer surface of the center key 115 are fundamentally prevented from rotating along with the rotating wheel 110. Therefore, the letters or logos of the center key are constantly provided to the user in a uniform direction.

### Holder

As shown in FIGS. 1, 2 and 6A and 6B, the holder 140 is a fixed member having a center hole 143 of a predetermined size perforated in a center thereof, and disposed between the rotating wheel 110 and the board 120 to rotatably support the rotating wheel 110 and assembled to the rotating wheel 110 by a fixing ring 142.

The holder 140 is provided with a plurality of guide protrusions 145 and 146 inserted through the guide holes 135 and 136 formed in the base 130, respectively to be exposed to the bottom of the base 130, and having lower ends thereof stuck into the guide holes 135 and 136, respectively.

Also, a plurality of pressing protrusions 144 are formed on the bottom of the holder 140. The pressing protrusions 144 align with the dome buttons 124 formed on the board 120 and have lower ends thereof in contact with the dome buttons 124 by a force resulting from pressing of the rotating wheel 110.

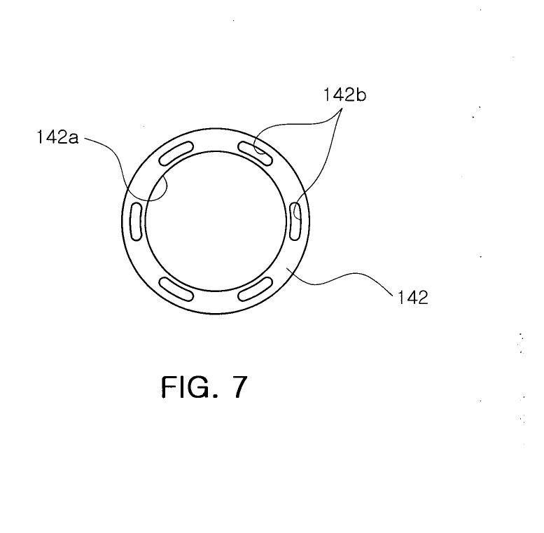

As shown in FIG. 7, the fixing ring 142 is formed of an annular ring-shaped member having an opening 142a of a predetermined size formed in a center thereof and having a plurality of rotating holes 142a perforated therein so that the plurality of fixing protrusions 118 protruded from the bottom of the rotating wheel 110 are inserted into the rotating holes 142b, respectively.

The rotating holes 142b each may have a predetermined central angle to control a rotational angle of the rotating wheel 110 rotatably supported by the holder 140. According to the present embodiment, six rotating holes 142b of a circular arc shape are formed in the fixing ring 142, but not limited thereto. The number of the rotating holes and a central angle thereof may be varied according to design conditions.

Here, the fixing ring 142 has an outer circumference greater than an inner circumference of the center hole 143 of the holder 140. Therefore, when assembled to the rotating wheel 110, the holder 140 is not detached downward. The opening 142a has an inner circumference substantially identical to or greater than a maximum outer circumference of the center key 115, thereby ensuring the center key 115 to be pressed well.

The guide protrusions 145 and 146 may be formed within a rotating radius of the rotating wheel 110 rotatably assembled to the holder 140.

As shown in FIGS. 1 and 2, the guide protrusions 145 and 146 include guiding parts 145a and 146a of a predetermined length disposed in the guide holes 135 and 136 of the base 130 to be vertically movable, respectively and sticking parts 145b and 146b formed at lower ends of the guiding parts 145a and 146a to be inserted through the guide holes 135 and 136 and stuck into the lower ends thereof, respectively.

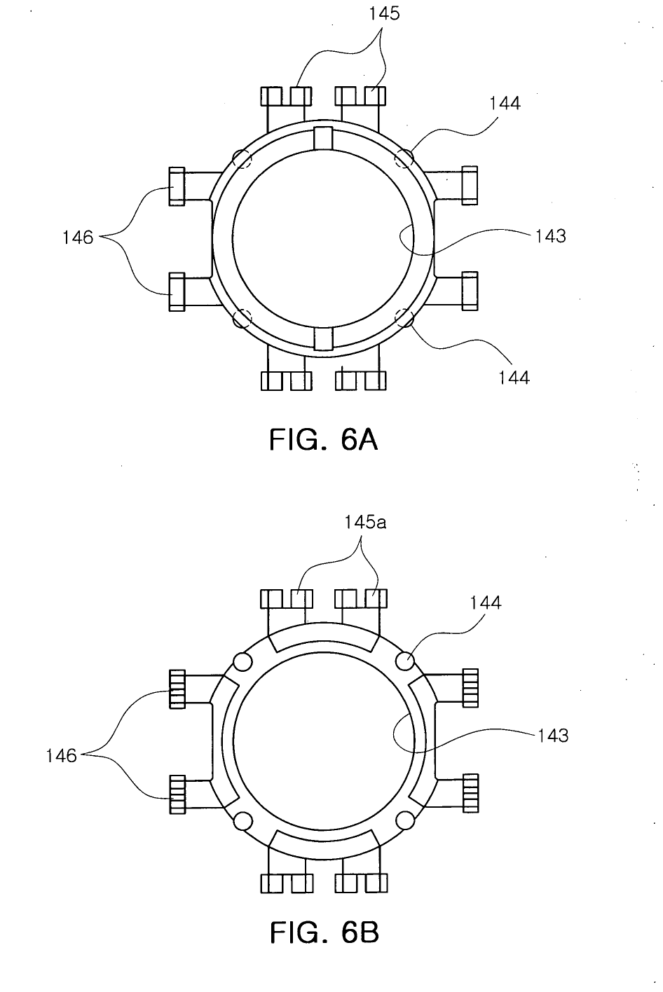

As shown in FIGS. 2, 6A and 6B, the sticking parts 145b and 146b each have an elastic tongue split apart and protruded outward, thereby generating an elastic force to a center thereof.

Accordingly, when the guide protrusions 145 and 146 of the holder 140 are inserted into the guide holes 135 and 136 of the base 130, respectively, the sticking parts 145b and 146b of the guide protrusions 145 and 146 are elastically retracted at upper ends of the guide holes 135 and 136, respectively and with decrease in the outer circumference thereof, are inserted through the guide holes 135 and 136.

Then, when the sticking parts 145b and 146b slip downward through bottom exits of the guide holes 135 and 136, respectively, the sticking parts 145b and 146b are split apart by an elastic restoration force generated when retracted, and thus with subsequent increase in the outer circumference thereof, stuck into the lower ends of the guide holes 135 and 136. Also, the guiding parts 145a and 146a are disposed on the guide holes 135 and 136 to be movable vertically and thus the holder can move vertically along with the rotating wheel by pressing of the user.

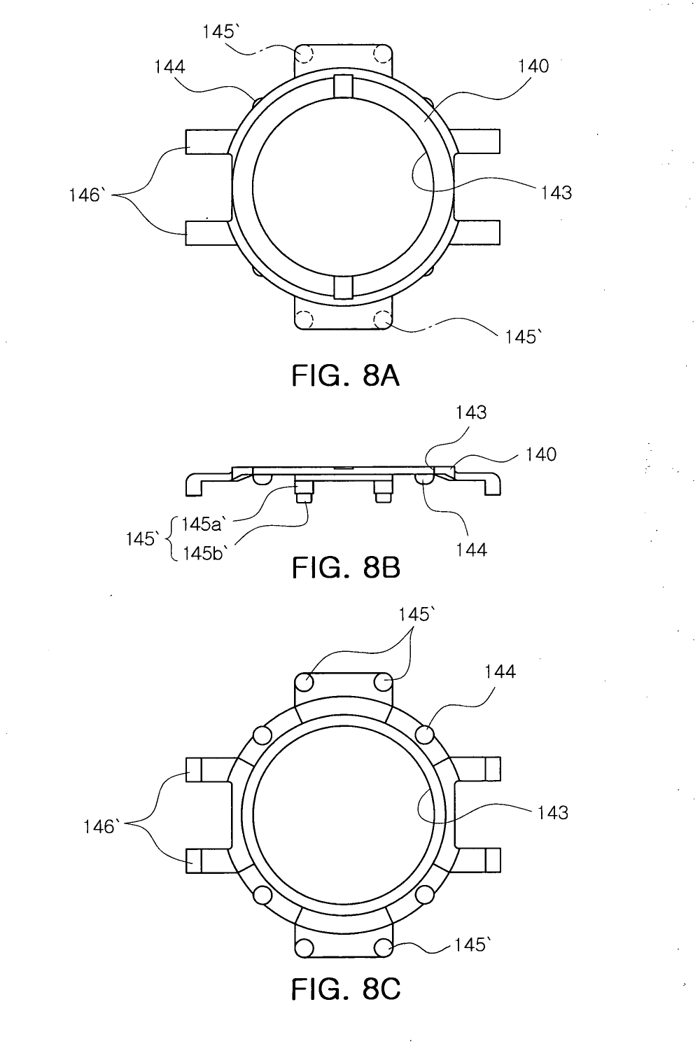

Meanwhile, as shown in FIGS. 8A, 8B and 8C, guide protrusions 145′ provided on the holder 140 each include a guiding part 145a′ of a predetermined length disposed on the guide holes 135 of the base 130 to be vertically movable, and a sticking part 145b′ inserted through the guide holes 135 and fused at a lower end of the guiding part 145a′.

Here, as shown in FIGS. 8A, 8B and 8C, the sticking part 145b′ is exposed downward through a corresponding one of the guide holes 135 and then fused by a heat source (not shown). Thus, the sticking part 145b′ is formed of a fusion protrusion extending from the lower end of the guiding part 145a′ to have an outer circumference greater than an inner circumference of the guide hole 135.

Accordingly, when the guide protrusion 145′ of the holder 140 is inserted in correspondence with the guide hole 135 of the base, the sticking part 145b′ of the guide protrusion 145′ is fitted through the guide hole 135 to be exposed downward.

In this state, a heat source is provided to fuse the sticking part 145b′ exposed downward through the guide hole 135 so that the sticking part 145b′ has an outer circumference greater than an outer circumference of the guide hole 135. This generates a force enabling the sticking part 145b′ to be stuck into the lower end of the guide hole 135. Also, the guiding part 145a′ is disposed in the guide hole 135 to be movable vertically, and thus the holder 140 can be moved vertically along with the rotating wheel 110 when pressed by the user.

Moreover, a guiding part 146a′ of another guide protrusion 146′ where the sticking part 145b′ is not formed is inserted into the other guide hole 136, thereby guiding vertical movement of the holder.

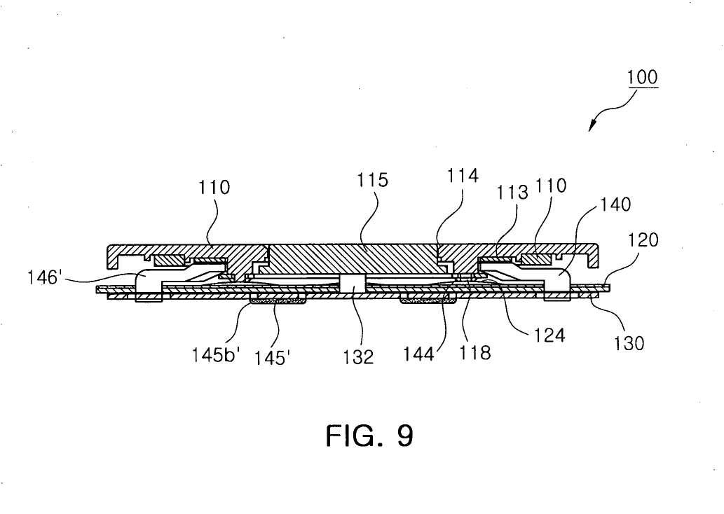

FIG. 9 illustrates a rotary input apparatus in which the sticking part 145b′ is fused to be stuck into the lower end of the guide hole 135, as described above.

In the rotary input apparatus structured above, when the user applies a rotating force to an outer periphery of the center key 115, the rotating wheel 110 is rotated in one direction with respect to the center key 115 and also the detected part 112 provided on the rotating wheel 110 is rotated along with the rotating wheel 110.

Furthermore, the detected part 112 may be formed of a ring-shaped magnet having an N pole and S pole disposed alternately in a circumferential direction, and the detecting part 122 disposed just below the detected part 112 may be formed of a hall sensor. In this case, the hall sensor senses change in magnetic pole resulting from rotation of the magnet, thereby perceiving a rotational direction, speed and angle of the rotating wheel 110.

Thereafter, an output signal generated from the hall sensor corresponding to a rotational direction, rotational speed and rotational angle is transmitted to an external controller through the board 120. The controller perceives the output signal and performs input according to rotation of the rotating wheel 110.

In addition, when the outer periphery of the center key 114 is pressed by the user, the holder 140 having the rotating wheel 110 assembled thereto is assembled such that the sticking parts 145 and 146 are stuck into the guide holes 135 and 136 formed in the base 130 to be vertically movable while not being detached upward. Therefore, with the rotating wheel 110 subsequently inclined in one direction, the pressing protrusions 144 protruded from the bottom of the holder 140 impose pressure on corresponding ones of the dome buttons 124, respectively.

In this case, the dome buttons 124 formed on the board 120 generate an operating signal to perform preset functions.

For example, the dome buttons 124 provided on a mobile terminal can be set to perform hot key functions such as activation of text message writing, phone number search, internet connection and satellite broadcasting receiving. The center dome button 124a corresponding to the center key 115 is set to perform an individual function.

As set forth above, according to exemplary embodiments of the invention, a plurality of guide protrusions are formed on a bottom of a holder disposed between a rotating wheel including a detected part and a base including a board. The guide protrusions are inserted into guide holes of the base to be exposed to a bottom of the base and thus have lower ends thereof stuck into the guide holes, respectively. This allows the guide protrusions of the holder assembled with the base to be disposed within a rotating radius of the rotating wheel. Accordingly, a portion where the base and the holder are assembled in an assembly line experiences minimum interference with other members, thereby further enhancing work efficiency and ensuring more freedom in design to allow various design changes in line with consumers' needs.

While the present invention has been shown and described in connection with the exemplary embodiments, it will be apparent to those skilled in the art that modifications and variations can be made without departing from the spirit and scope of the invention as defined by the appended claims.

1. A rotary input apparatus comprising:
a rotating wheel having a detected part;
a board provided with a detecting part detecting the detected part rotating along with the rotating wheel;
a base having the board disposed on a top thereof and provided with a plurality of guide holes therein; and
a holder having the rotating wheel rotatably assembled therewith, and provided with a plurality of guide protrusions inserted through the guide holes to be exposed to a bottom of the base and having lower ends thereof stuck into the guide holes, respectively, the holder disposed between the rotating wheel and the board.

2. The rotary input apparatus of claim 1, wherein the holder has a center hole of a predetermined size perforated in a center thereof to be assembled with the rotating wheel by a fixing ring.

3. The rotary input apparatus of claim 2, wherein the fixing ring has a plurality of rotating holes perforated therein to have a plurality of fixing protrusions protruded from a bottom of the rotating wheel inserted thereinto.

4. The rotary input apparatus of claim 1, wherein the guide protrusions are disposed within a rotating radius of the rotating wheel.

5. The rotary input apparatus of claim 1, wherein each of the guide protrusions comprises:
a guiding part of a predetermined length disposed in a corresponding one of the guide holes of the base to be vertically movable; and
a sticking part formed on a lower end of the guiding part, the sticking part inserted through the guide hole to be stuck into the lower end of the guiding part.

6. The rotary input apparatus of claim 5, wherein the sticking part is formed of an elastic tongue split apart to generate an elastic force in a center thereof and protruded outward.

7. The rotary input apparatus of claim 5, wherein the sticking part is exposed downward through the guide holes and fused by a heat source to form a fusion protrusion having an outer circumference greater than an inner circumference of the guide hole.

8. The rotary input apparatus of claim 1, wherein the rotating wheel further comprises a center key inserted into a center hole perforated in the center thereof.

9. The rotary input apparatus of claim 1, wherein the center key has a flap formed on a lower end thereof to be stuck into a step formed on an inner surface of a center hole.

10. The rotary input apparatus of claim 1, wherein the rotating wheel is provided on a bottom thereof with a positioning recess where the detected part is positioned.

11. The rotary input apparatus of claim 1, wherein the rotating wheel is provided in a bottom thereof with a slip ring groove where a slip ring is disposed to abut against a top of the holder.

12. The rotary input apparatus of claim 1, wherein the detecting part is formed of one of a hall sensor, a magneto resistor and a great magneto resistor.

13. The rotary input apparatus of claim 1, wherein the board comprises a plurality of dome buttons generating a signal when in contact with a plurality of pressing protrusions protruded from a bottom of the holder, respectively.

14. The rotary input apparatus of claim 1, wherein the board comprises a plurality of center dome buttons generating a signal when in contact with a center key inserted into a center hole perforated in a center of the rotating wheel.

15. The rotary input apparatus of claim 13, wherein the center dome buttons or dome buttons are formed of one of a pressure sensor and a contact sensor.

16. The rotary input apparatus of claim 1, wherein the base comprises a vertical rib of a predetermined height having an upper end stuck into a center key inserted in a center hole perforated in the rotating wheel to prevent the center key from rotating.

17. The rotary input apparatus of claim 14, wherein the center dome buttons or dome buttons are formed of one of a pressure sensor and a contact sensor.
